(19) United States
(12) Patent Application Publication
(10) Pub. No.: US 2002/0099610 A1
(43) Pub. Date: Jul. 25, 2002

(54) Shopping cart

(76) Inventor: Kenneth O. Marion, Greensboro, NC (US)

Correspondence Address: WITHROW & TERRANOVA, P.L.L.C., P.O. BOX 1287, CARY, NC, 27512, US

(21) Appl. No.: 10/105,982

(22) Filed: Mar. 25, 2002

Related U.S. Application Data
(63) Continuation of application No. 09/473,666, filed on Dec. 29, 1999.

(51) Int. Cl. G06F 17/60; G06G 1/12

(52) U.S. Cl. 705/21; 705/14

(57) ABSTRACT

A shopping cart transmits customer information to a store information display system and a checkout system thereby providing individualized pricing or advertising information and automated checkout services to one or more customers operating such shopping carts. A store includes various product display areas with one or more information display units (IDUs) mounted proximate to the various product display areas. The IDUs display pricing related to the proximate products, and can also display advertising information. A customer information input device (CIID) is associated with each product display area and is adapted to receive the customer information transmitted by a browsing customer's proximate shopping cart. Pricing information displayed on the IDUs associated with the CIID through which the customer information was received is updated based on the customer information. This allows a store to display individualized pricing to a browsing customer based on, for example, that customer's standing in a store loyalty program. The shopping cart is further adapted to transmit customer information to a checkout system for the purpose of automatically applying loyalty program benefits associated with the customer during the checkout transaction. If the customer has previously given the store permission, credit account information may be automatically associated with the customer information received from the shopping cart. In this manner, charges for the transaction may be automatically assessed against a customer's credit account, thereby saving checkout time and reducing complexity for both the customer and checkout system operator.

### FIELD OF THE INVENTION

The present invention generally relates to individualizing retail store pricing and checkout services and specifically relates to providing a shopping cart adapted to transmit customer information enabling such individualized services.

### BACKGROUND OF THE INVENTION

Retail stores compete for customers based on price, service, and selection. With normally very narrow profit margins, stores compete aggressively with one another to attract and maintain a loyal base of regular customers. Because of the narrow profit margins, volume sales are key to acceptable earnings in the retail space. As such, stores have an incentive to offer generalized pricing and services in the interest of simplifying sales to a large number of customers. Yet such generalized pricing and service can be a disadvantage in the sense that it runs counter to a given retail store being able to differentiate itself from competitors. A given retail store or chain of stores benefits from having a reliable and preferably growing base of repeat customers. Stores commonly administer some form of a customer loyalty program intended to foster repeat business. In such programs, stores reward regular or repeat customers with price discounts and promotional offers not available to the general shopping public. Typical store loyalty programs require a customer to submit some form of an application or registration to gain membership in the program. Once registered, the member customer becomes eligible for the various price discounts and promotional items offered by the store. Present store loyalty programs are rather simplistic, defining a given customer as belonging to one of two categories, member or non-member, with the former eligible for loyalty program discounts and the latter ineligible. The simplicity of current store loyalty programs limits the effectiveness of such programs in maintaining and attracting a loyal base of repeat customer, yet the simplicity is understandable.

Substantially increasing the sophistication and attractiveness of customer loyalty programs requires tailoring the in-store shopping experience to an individual customer. Individualizing the shopping experience includes providing customer-specific pricing, product information and advertising in and around the various product display areas, as well as automatically applying those customer-specific pricing discounts and product promotions at checkout. Of course, individualizing the shopping experience must not impose any additional complexity on the individual member and non-member customers. Despite the attractiveness of individually tailoring the in-store shopping experience, stores face significant challenges in implementing systems supporting such individualized shopping experiences.

Retail stores typically arrange their goods and products on long rows of shelves arranged in aisles, providing convenient access to these goods and products for customers moving up and down the various aisles. Generally, plastic or paper placards mounted proximate to a given brand of product provide browsing customers with pricing and other relevant product information. Very often, these placards are disposed on the leading edges of the various shelves so that their position is roughly in front of or under the specific product pertaining to their printed information. Such placement allows a customer to easily determine the correspondence between printed pricing information and the product. While straightforward, this placard-based pricing system has several shortcomings.

One shortcoming is the inability to change displayed product information with minimal labor or time expense. With printed placards, changing the price for a displayed product literally entails printing a new price placard and installing it in place of the old placard. Stores often vary the discounts and promotions available to member customers week-to-week or even day-to-day. This variation in discounted product selections requires stores to maintain an ever-changing set of pricing and promotional displays. Stores usually display pricing and product information for general customers and supplement this information with discount or promotional information pertaining only to loyalty program member customers. Such practices permit browsing customers to see both regular and discounted pricing information but displaying incentive pricing in this way has several disadvantages. Displaying multiple prices for a single product or service invariably confuses customers as to which price they will pay at the register. Oftentimes, general customers assume the discount price applies to them, not realizing the price only applies to customers who are loyalty program members. Further, the opportunities to recognize various levels of price discounts based on loyalty program membership level are severely limited with printed placard price displays.

Additionally, checkout systems are not equipped to individually identify customers for the purpose of applying related loyalty program membership discounts on an individualized basis. Currently, store loyalty program discounts are applied by the checkout system in a binary fashion, member customers all receive a single common discount for one or more given products and non-member customers receive no discount at all. Significant opportunities to enhance the attractiveness of a store's loyalty program are lost through such simplistic application of membership benefits.

Accordingly, there remains a need for a system that permits a store to individualize the shopping experience and maintain a sophisticated customer loyalty program tailored to individual customers or specific groups of customers. Ideally, such a system would provide for the automatic identification of individual customers so that individualized pricing and checkout services could be provided to each customer as they browse the product display areas and, ultimately, conduct their purchase transactions at the checkout register. The present invention, as is described herein and illustrated in accompanying drawings, provides means for administering sophisticated customer loyalty programs providing individualized services for each loyalty program member customer.

### SUMMARY OF THE INVENTION

The present invention provides a shopping cart adapted to function with an information display system that may be advantageously used in a retail store environment to provide individualized pricing and advertising to a plurality of customers. Individualized pricing, as afforded by the information display system, permits a retail store to display default or general pricing and advertising to customers that are not members of a store loyalty program, while providing member customers with price discount and special promotional offer information. The information display system includes a plurality of information display units (IDUs) arranged in groups, with each group associated with and proximate to a certain product or products. A customer information input device (CIID) is associated with each IDU or each group of IDUs and is adapted to receive customer information. When a CIID receives customer information from a browsing customer, its associated IDUs dynamically change to display individualized information, including special loyalty program price discounts and promotional offers.

The shopping cart of the present invention is adapted to transmit customer information to the various CIIDs. In response to receiving the customer information through a given CIID, the IDUs associated with that given CIID dynamically change from displaying default pricing and advertising to display special price discounts and promotions based on the received customer information. This permits a browsing customer using the shopping cart of the present invention to automatically receive individualized pricing and promotional information from the various IDUs. The shopping cart of the present invention is additionally adapted to communicate with a customer information receiver (CIR) mounted proximate to a checkout system. The checkout system is operatively associated with the CIR and automatically receives customer information transmitted by the shopping cart as the customer approaches the checkout system. The checkout system automatically applies any special discounts or promotional offers based on the customer information received from the shopping cart through the checkout system's associated CIR. Optionally, payment information may also be associated with the customer information, allowing the checkout system to automatically charge the transaction cost to a customers credit or other payment account.

### BRIEF DESCRIPTION OF THE DRAWINGS

FIG. 1 is a simplified block diagram depicting the system of the present invention.

FIG. 2A is a block diagram of the customer information input device, shopping cart, and customer-carried transmitter in the preferred embodiment of the present invention.

FIG. 2B is a block diagram of the customer information input device, shopping cart, and customer-carried information card in an alternate embodiment of the present invention.

FIG. 2C is a block diagram of the customer information input device, and customer-carried transmitter in an alternate embodiment of the present invention.

FIG. 2D is a block diagram of the customer information input device and customer-carried information card in an alternate embodiment of the present invention.

FIG. 2E is a block diagram of the customer information input device with a keypad in an alternate embodiment of the present invention.

FIG. 3A is a block diagram of the shopping cart and checkout system in the preferred embodiment of the present invention.

FIG. 3B is a block diagram of the customer-carried transmitter and checkout system in the preferred embodiment of the present invention.

FIG. 4 is a simplified block diagram illustrating the system of the present invention in its preferred embodiment.

FIG. 5 is a simplified logic flow diagram of the operating logic for displaying providing individualized pricing information.

FIG. 6 is a simplified logic flow diagram of the operating logic for applying individualized customer information during checkout.

### DETAILED DESCRIPTION OF THE INVENTION

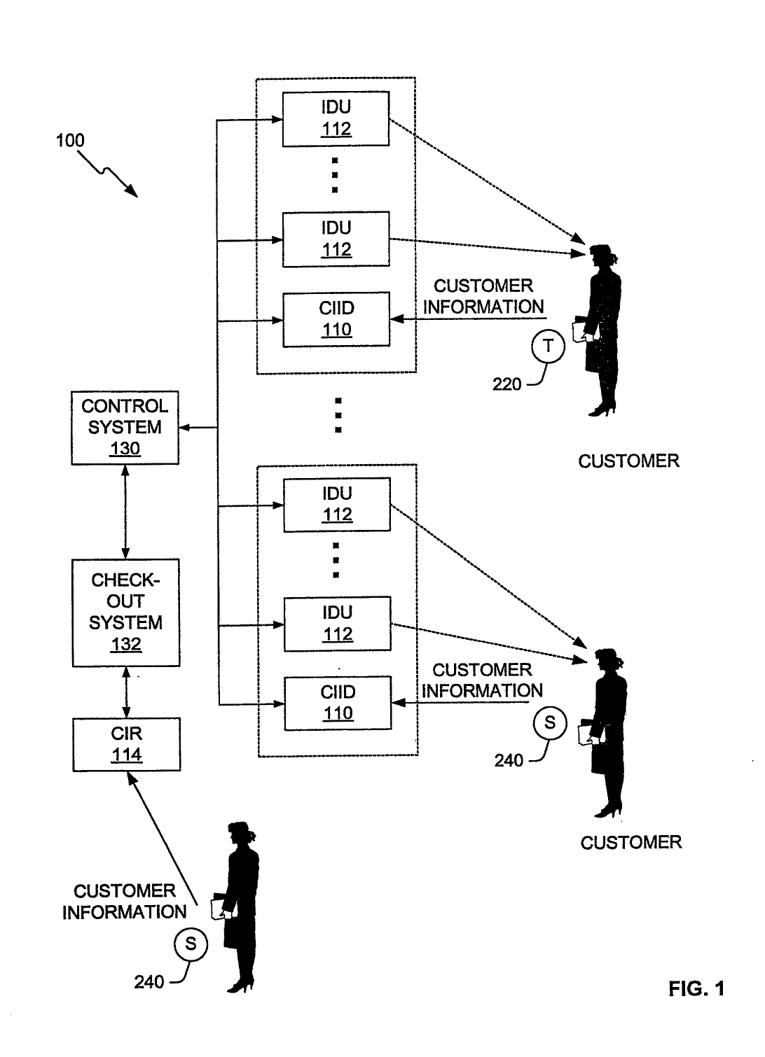

FIG. 1 broadly illustrates the present invention. The information display system 100 provides individualized display pricing and advertising information to one or more customers. In a retail environment, one or more information display units (IDUs) 112, together with an associated customer information input device (CIID) 110 are mounted proximate to a given product or group of products. The preferred embodiment of the present invention provides a plurality of CIIDs 110, with each CIID 110 associated with one or more IDUs 112. In a default state of operation, a control system 130 causes each IDU 112 to display default product information relevant to nearby products. Since each IDU 112 displays product information related to nearby products, browsing customers are able to easily correlate display information, including pricing, with corresponding products. In this manner, a general customer may browse the various product displays and receive default or generalized product and price information from the various IDUs 112 distributed throughout the retail environment or store.

To foster customer loyalty, the store may offer price discounts or special promotional offers on a varying mix of products to those customers having membership in a store-run loyalty program. To denote loyalty program membership, the store records customer information specific to each member customer, comprising at least a customer identifier. The system of the present invention provides individualized product information, including loyalty program-based price discounts, to member customers while browsing product aisles and while checking out. A member customer proximate to a particular CIID 110 transfers their customer information into that CIID 110. The customer information may be input to the CIID 110 automatically, or may require manual input by the member customer. Once a particular CIID 110 receives member customer information, it transfers this information back to the control system 130. In the preferred embodiment, member customer information received through the particular CIID 110 includes customer indicia uniquely identifying the individual customer member. Using this identifying customer information, the control system accesses additional information for the member customer in an associated database. The associated database may include detailed product purchasing histories for the member customer, with such histories automatically developed in cooperation with an adapted checkout system 132. The associated database may further include product preferences for the member customer, and preferably, includes credit information supporting automated transaction processing.

Based on the customer information received through the particular CIID 110, the control system 130 develops and transmits updated pricing and product information for each of the IDUs 112 associated with the particular CIID 110. Preferably, the proximate member customer is alerted to the presence of updated discount pricing audibly or visually. In this manner, the store may conveniently maintain any number of loyalty program price discount levels and promotional offers, keyed to a member customer's particular standing within the loyalty program. After a defined period of time, or after the member customer leaves the area immediately proximate to the particular CIID 110, its associated IDUs 112 return to displaying default product information.

The preferred embodiment of the present invention imparts these same customer-specific pricing and promotional advantages to a checkout system 132 adapted to receive customer information through a proximate customer information receiver CIR 114. The CIR 114 may be implemented using the same technology as CIIDs 110, or may be based on a different technology. In the preferred embodiment, the member customer information includes identifying customer indicia, and the checkout system 132 transfers this information to the control system 130. The control system 130 accesses the associated database described above to obtain credit information corresponding to the member customer information it received from the checkout system 132. The control system 130 transfers the stored credit information, along with any loyalty program information to the checkout system 132. This permits the checkout system 132 to automatically apply loyalty program price discounts to eligible products based on an individual customer's level of loyalty program membership, and to automatically secure payment for the purchase transaction based on the member customer's credit information. For enhanced security, the checkout system 132 in the preferred embodiment requires the member customer to input a PIN or other supplemental identifying information. The checkout system 132 then verifies the member customers credit information and PIN with an outside authorizing network. Note that customer information received through a given CIID 110 or the checkout system CIR 114 may simply receive identifying customer indicia, as in the preferred embodiment, or may include additional information, including credit information, purchasing history, and product preferences.

Obtaining Customer Information at CIIDs

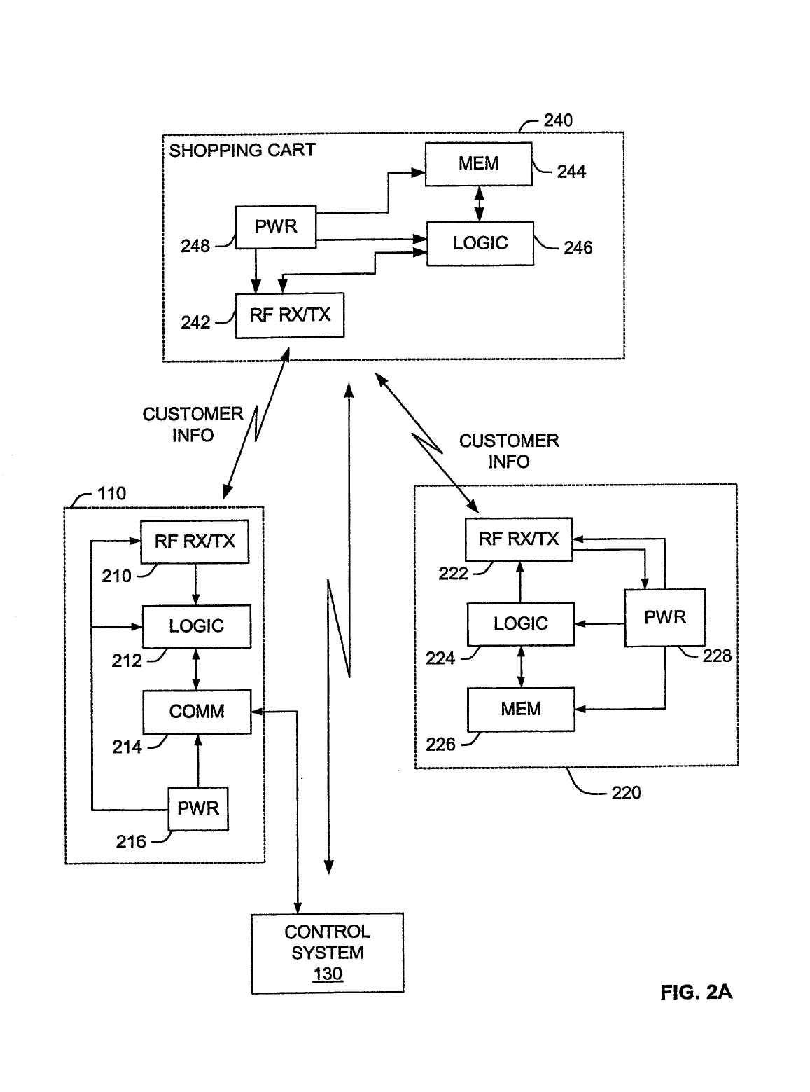

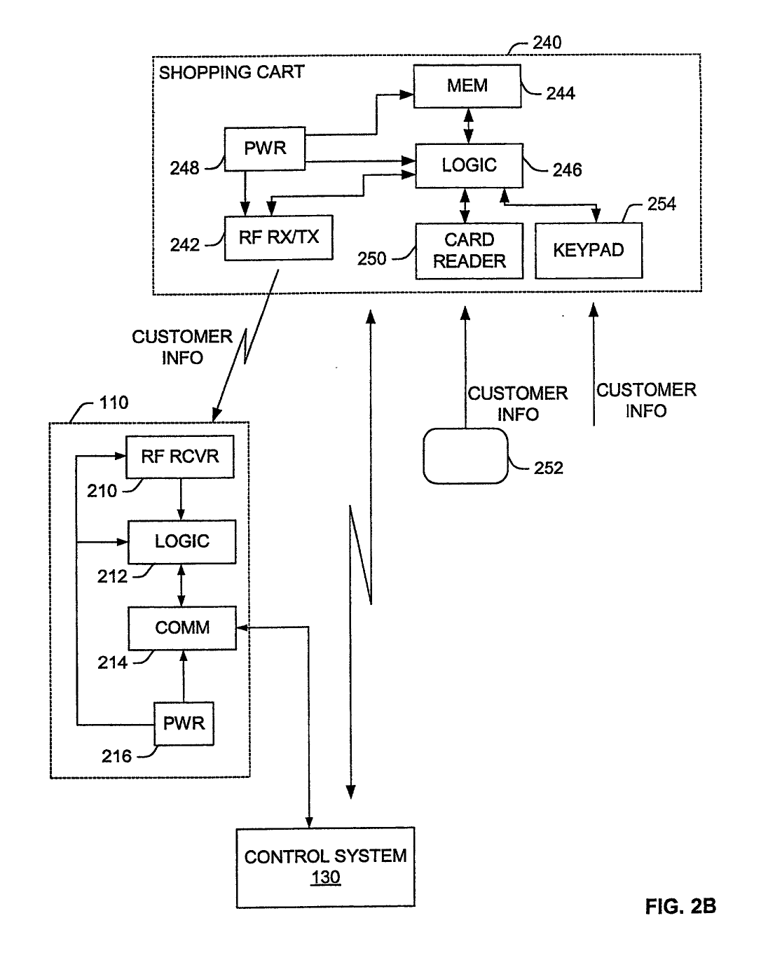

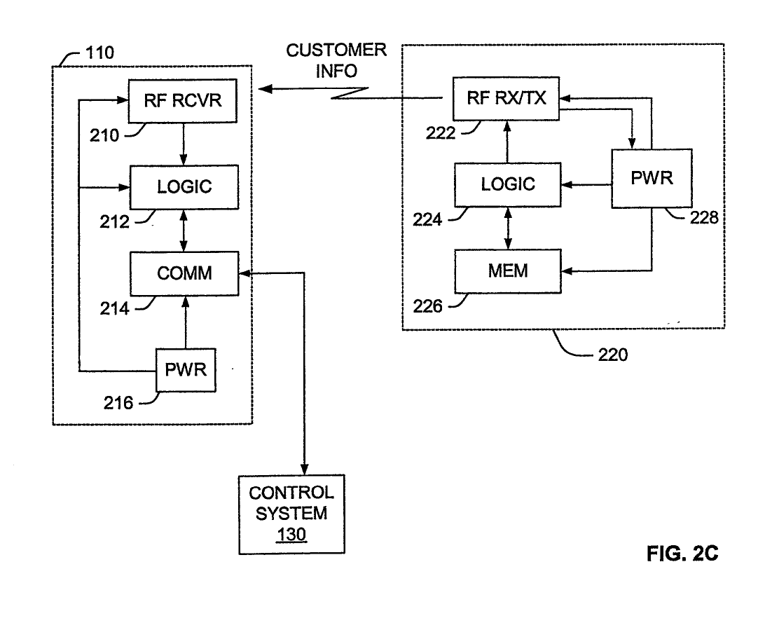

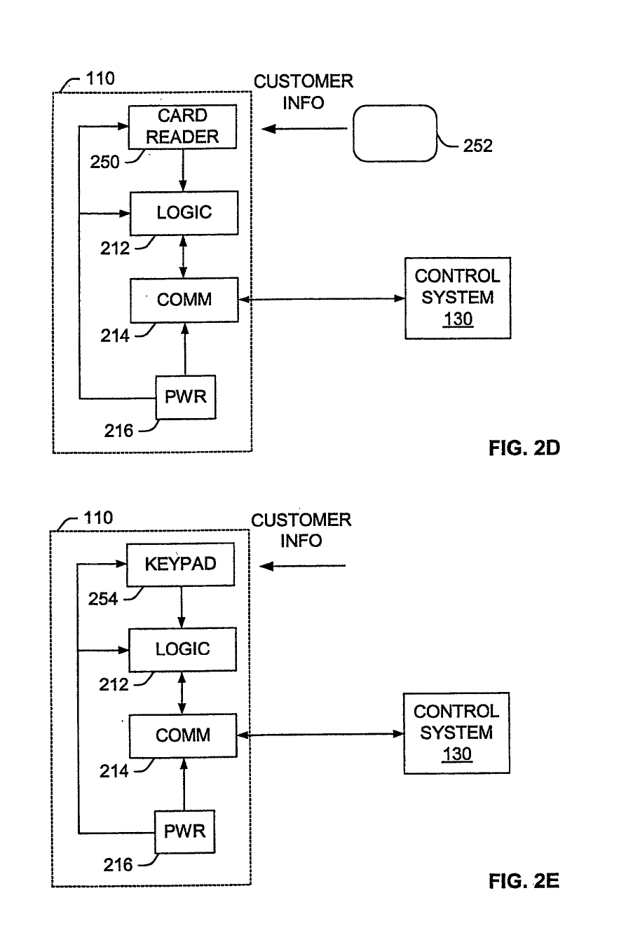

FIG. 2A illustrates the preferred embodiments for the CIIDs 110, a shopping cart 240, and a customer-carried transmitter (RF transponder) 220. A store assigns a customer-carried transmitter 220 to each member customer. The customer-carried transmitter 220 contains individual customer information related to the member customer to whom it is assigned. In the preferred embodiment, the information display system 100 includes shopping carts 240 adapted to receive and store customer information from the customer-carried transmitter 220 and subsequently transmit its stored customer information to a proximate CIID 110 or directly to the control system 130. In the preferred embodiment, the shopping cart 240 includes a logic element 246 for controlling radio reception and transmission through an RF transceiver 242, and for writing and reading customer information to and from a non-volatile memory element 244. A power supply 248 provides operating power to the foregoing shopping cart electronics.

In the preferred embodiment, the customer-carried transmitter 220 does not include an internal battery or other self-contained power source; rather its operating power is derived from an interrogation signal emitted by the shopping cart 240 or by the CIID 110 or CIR 114. An RF transceiver 222 in the transmitter 220 transfers the interrogation signal emitted by the shopping cart 240 to a power converter 228. Power converter 228 stores a portion of the energy received in the interrogation signal and uses this stored energy to power the remaining transmitter 220 electronics. With power from the power converter 228, a logic element 224 reads stored customer information from a non-volatile memory element 226, which also receives operating power from the power converter 228. The logic element 224 transfers this stored customer information to the RF transceiver 222, where it is transmitted to the shopping cart 240. The logic element 246 receives the customer information transmitted by the customer-carried transmitter 220 through the RF transceiver 242. The logic element 246 writes the received customer information to the memory element 244. The logic element 246 is programmed to periodically transmit the customer information so that a browsing member customer has their customer information automatically transferred to a proximate CIID 110. Alternatively, a proximate CIID 110 can periodically emit an interrogation signal, causing the shopping cart 240 or customer-carried transmitter 220 to respond by transmitting the customer information.

The transmit range for both the customer transmitter 220 and the shopping cart 240 is restricted, thus avoiding unintended communication with CIIDs 110 outside the member customer's immediate location. The proximate CIID 110 receives customer information through an RF transceiver 210 under control of a logic element 212. The logic element 212 receives the customer information and formats it for transfer to a communications interface 214. A power supply 216 provides operating power for the CIID 110. The communications interface is in wired communications with the control system 130. The customer information received from the shopping cart 240 through the proximate CIID 110 is transferred back to the control system 130, along with identifying information for the CIID 110. In this manner, the control system 130 can identify not only the customer associated with the received customer information, but can identify the CIID 110 through which the customer information was received, thereby enabling the control system 130 to determine which IDU(s) 112 to update with individualized customer-specific pricing and promotional information. By designing the customer-carried transmitter 220 as a passive RF transponder, maintenance issues are avoided in terms of not having to replace transmitter batteries. In contrast, the shopping cart 240 easily carries a power source, such as a rechargeable battery, suitable for interrogating customer transmitters 220 and subsequently transmitting the information at timed intervals while the member customer is browsing the product displays. Conventional holding racks for shopping carts may be adapted to provide automatic battery recharging for the shopping cart 240 of the present invention.

FIG. 2B depicts an alternate embodiment for the shopping cart 240. In this embodiment, a customer-carried card 252 replaces the customer-carried transmitter 220. The card 252 may be magnetic, optical, or electronic, and the shopping cart 240 includes a compatible card reader 250. Examples of these different card technologies include magnetic stripe types, optical indicia types, and electronic or “smart card” types. A member customer swipes or otherwise causes their card 252 to transfer its information to the shopping cart 240 via card reader 250. Once customer information is received through the card reader 250, the shopping cart 240 behaves as described in the preferred embodiment.

An alternate embodiment of for the customer-carried transmitter appears in FIG. 2C. In this embodiment, the customer-carried transmitter 220 is an active RF transponder operating under its own power. Thusly, the power source 228 is typically a battery or other self-contained power source. With an internal battery, a customer-carried transmitter could transmit to either CIIDs 110 or CIR 114 without need for an interrogation signal. FIG. 2D depicts an alternate embodiment in which the CIIDs 110 include a card reader adapted to receive customer information from a compatible customer-carried card 252. Again, the card 252 can be any suitable magnetic, optical, or electronic card. FIG. 2E illustrates yet another embodiment of the present invention. In this embodiment, each CIID 110 includes a keypad 254. Using the keypad 254, a member customer enters customer information (typically identifying indicia) directly into a given CIID 110. Once the given CIID 110 receives the customer information through the keypad, this information is transferred to the control system 130 and subsequent operation is identical to the other embodiments described above.

Note that the embodiments described above and shown in FIG. 2A-2E are simply a few of the many variations available for transferring customer information from a browsing member customer into one or more CIIDs 110. For example, the information display system 100 of the present invention may include both passive and active RF transponders serving as customer-carried transmitters 220. In this configuration, both the shopping carts 240 and the CIIDs 110 are adapted to interrogate passive versions of the transmitter 220, thereby permitting those member customers carrying passive transmitters 220 to transfer their information into a proximate CIID 110 through a shopping cart 240 or directly from their passive transmitter 220. For those customers with active transmitters 220, both the shopping carts 240 and the CIIDs 110 are capable of receiving customer information directly.

In another embodiment of the present invention, an individual customer enters their customer information into the shopping cart 240 via customer-carried transmitter 220, customer card 252, or keypad 254. The shopping cart 240 stores this information in its memory. The shopping cart 240 communicates directly with the control system 130 via wireless signal to determine the loyalty program membership level of the customer. The control system 130 transmits loyalty program information back to the shopping cart 240. Optionally, the control system 130 transmits payment or credit information back to the shopping cart 240, if a customer has configured their loyalty program account to include such information. Subsequently, as the customer approaches a proximate IDU 112, the shopping cart 240 transmits the customer information, including the loyalty membership level to the CIID 110 associated with the proximate IDU 112. In response, the information shown on the IDU 112, either pricing or advertising, or both, is updated in response to receiving the customer loyalty information.

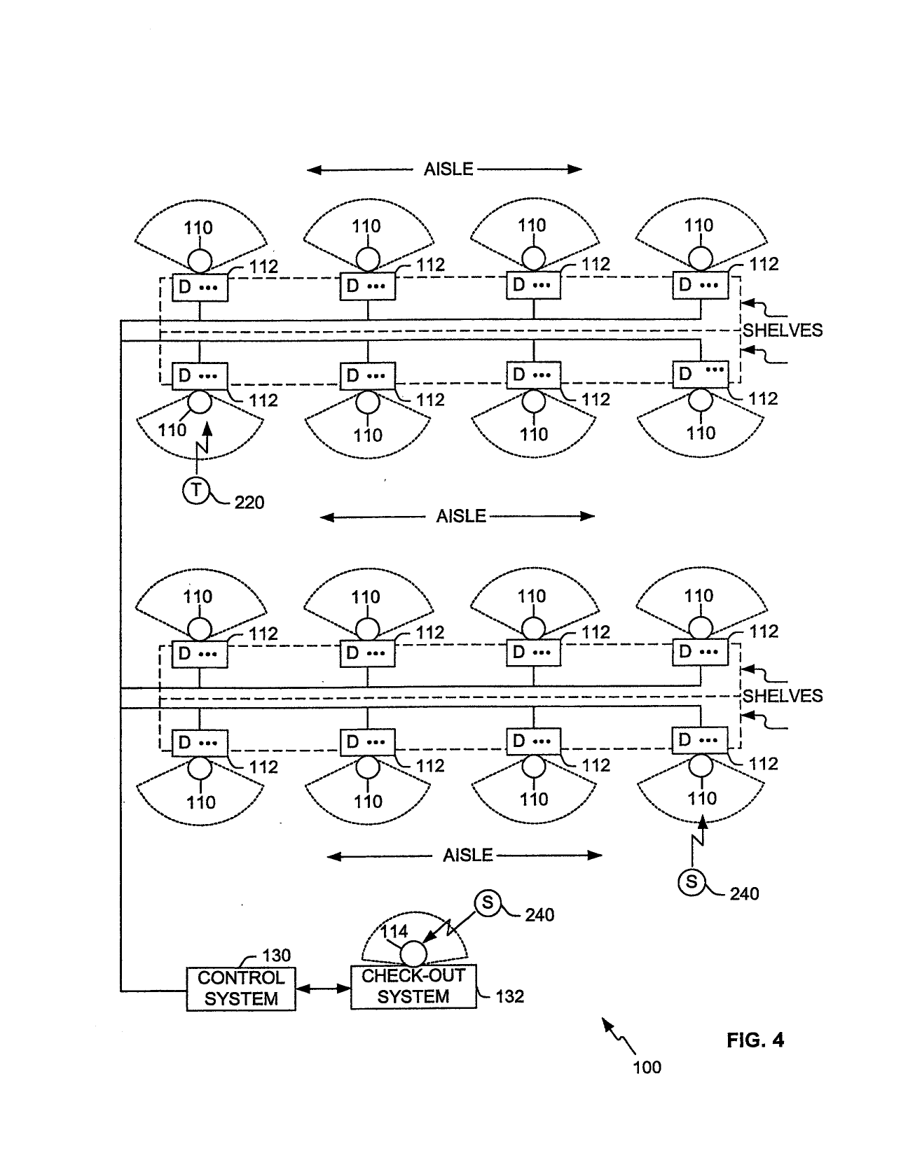

FIG. 4 illustrates the system 100 of the present invention with a plurality of IDUs 112 distributed throughout the retail environment. Note that each IDU 112 block in the diagram is associated with a proximate CIID 110 and can comprise an individual IDU or several separate IDUs. The control system 130 is programmed with information related to the physical layout of the various IDUs 112 and CIIDs 110 and therefore has knowledge regarding which IDUs 112 are associated with which CIIDs 110. A browsing customer carrying a transmitter 220 approaches a given CIID 110 and, once the customer enters the reception range of the given CIID 110—as indicated by the dotted fan shapes associated with each CIID—customer information is received by the given CIID 110 via a wireless signal from the transmitter 220. The customer-carried transmitter 220 transmits the information actively, or in response to an interrogation signal emitted from the CIID 110. The control system 130 receives this customer information from the given CIID 110 and accesses loyalty program information for the individual customer from an associated database. In addition, the control system 130 may additionally access purchasing history information or product preference information from the database. The control system 130 uses the stored database information associated with the individual customer's information to develop individualized product pricing information and, optionally, individually targeted product or promotional advertising. This individualized pricing and product information is then sent by the control system 130 to the IDU 112 or IDUs 112 associated with the CIID 110 through which the customer information was received.

FIG. 4 also illustrates the transfer of a given customer's customer information from a shopping cart 240 into a given CIID 110. The shopping cart 240 is specifically adapted to receive and transmit an individual customer's customer information, as is detailed later. Again, a browsing customer, having already transferred their customer information into the shopping cart 240, approaches a given CIID 110 with their shopping cart 240 and has their customer information automatically transferred from the shopping cart 240 to the CIID 110. As with the customer-carried transmitter 220, their customer information is used by the control system 130 to provide individualize pricing and product information on the IDUs 112 associated with the given CIID 110.

FIG. 4 additionally illustrates the automatic transfer of customer information for an individual customer at a checkout system 132. The checkout system 132 cooperates with a proximate CIR 114 to receive customer information either from a given customer's shopping cart 240, or a given customers transmitter 220. The CIR 114 may be similar or identical to the CIIDs 110. The shopping cart 240 and the customer-carried transmitter 220 may be adapted to transfer different information to the CIR 114 of the checkout system 132 as compared to the information transmitted to a given CIID 110. For example, if the customer has elected to have credit information or payment information stored in association with their customer information, the credit portion of the customer information may be transmitted only to the CIR 114 at the checkout system 132. The following section provides additional details regarding checkout operations in the present invention.

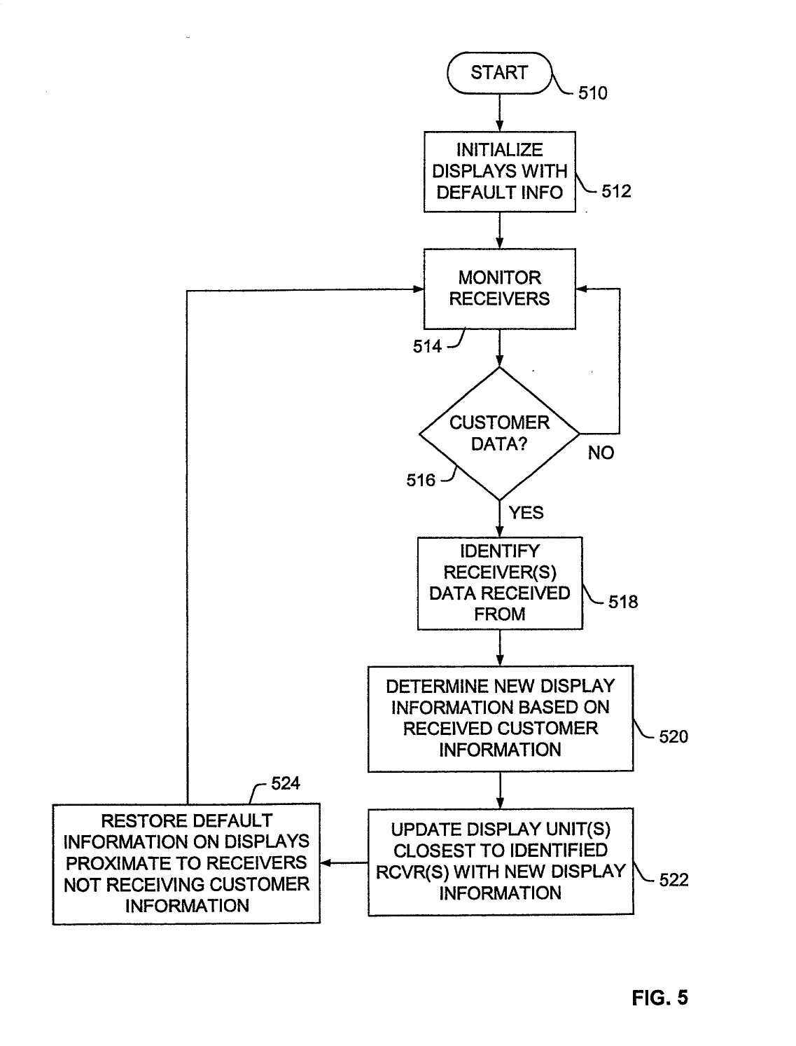

FIG. 5 illustrates simplified, general operation for the information display system 100. Operations begin (block 510) with the control system 130 initializing the individual IDUs 112 with default pricing and product information (block 512). For a given IDU 112, this default information includes general or default prices for the product or products proximate the given IDU 112. The control system 130 monitors the various CIIDs 110 (block 514) to determine if one or more CIIDs 110 has received customer information from one or more browsing customers (block 516). Absent incoming customer information, the control system 130 maintains default display information on the various IDUs 112. When one or more CIIDs 110 receive customer information, the control system 130 identifies the specific CIIDs 110 through which the customer information was received (block 518) and determines new display information based on the received customer information, with new display information determined for each individual customer for which customer information was received (block 520). The control system 130 transmits this new pricing and product information the IDU(s) 112 associated with each CIID 110 through which customer information was received (522). In this manner, one or more browsing customers receive individualized pricing and product information on the IDUs 112 proximate to CIID 110 closest to each of the browsing customers. All of the IDUs 112 associated with CIIDs 110 through which no customer information was received are restored to displaying default product and pricing information (block 524). Restoring default information to a given IDU 112 that is currently displaying individualized pricing and product information may occur automatically after a defined time-out interval, or may occur after a proximate member customer leaves a defined area around a CIID 110.

In general, the shopping cart of the present invention permits customers to receive individualized pricing and promotional information throughout a retail stores product display area, and to enjoy reduced checkout transaction times through automatic transfer of customer information, including loyalty and, optionally, payment information, at checkout time. Those skilled in the art will readily appreciate the various means available inputting customer information into the shopping cart of the present invention and will recognize that the functionality of the present invention does not depend upon a specific implementation. Rather, any shopping cart adapted to automatically identify an individual customer to an information display system, including the various information display units and checkout register such as described herein, is within the scope of the present invention. The shopping carts 240 may communicate with the control system 130 through the various CIIDs 110 and CIR 114 or may communicate directly via wireless signal. With such direct communications, the amount of information exchanged between the CIIDs 110 and control system 130 could be reduced, as the control system 130 could communicated loyalty program standing and credit information for a given customer directly to the shopping cart 240. The shopping cart 240 could then transmit loyalty program information directly to a CIID 110, which could then cooperate with its associated IDUs 112 to display updated pricing and advertising information. Those skilled in the art will readily appreciate the many variations possible for implementing the system described herein. All such variations such variations are considered within the scope of the present invention.

Customer Information at the Checkout System

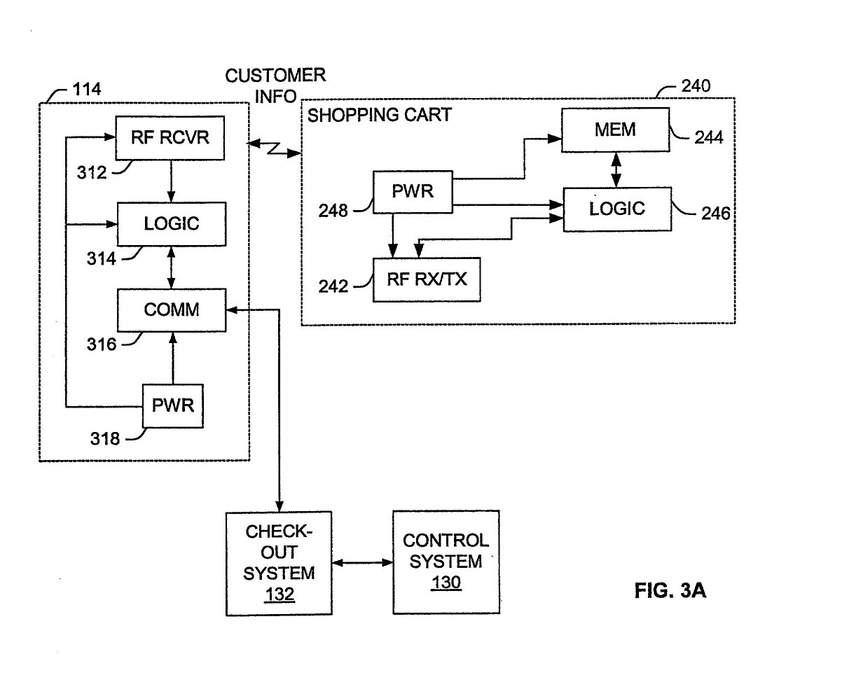

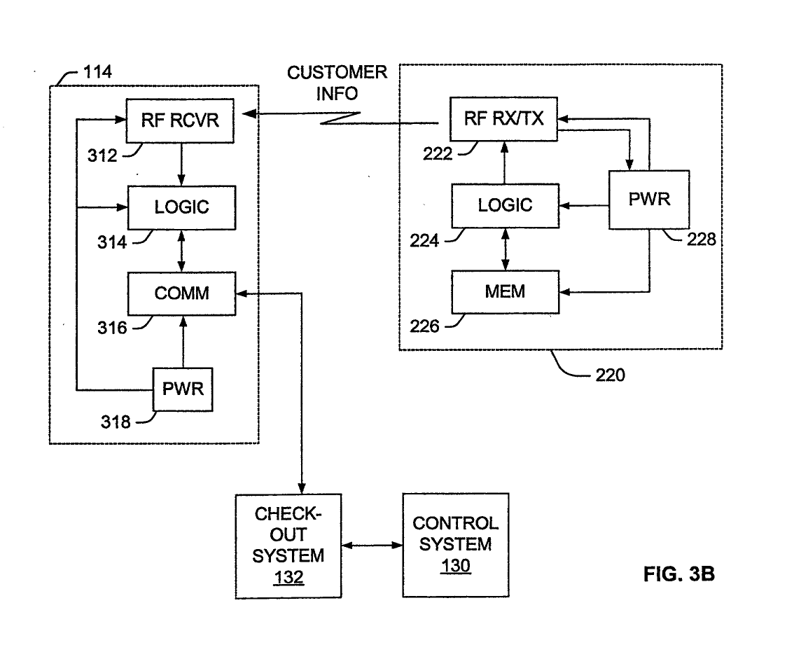

Referring to FIG. 3A for the preferred embodiment of the present invention, a given member customers information is automatically transferred from a given shopping cart 240 into the checkout system 132 through a dedicated CIR 114 mounted in close proximity to the checkout system 132. In operation, as a member customer approaches the checkout system 132 with a given shopping cart 240, their customer information is transmitted from the given shopping cart 240 into the checkout system 132 through CIR 114. In the preferred embodiment, the customer information received through CIR 114 includes identifying customer indicia. The checkout system 132 transfers this customer information to the control system 130. The control system 130 accesses an associated database based on the customer information received from the checkout system 132. Member customer information stored in the associated database corresponding to the identifying customer indicia preferably includes loyalty program membership information, product preference information, and credit information. The control system retrieves this stored information and transfers it to the checkout system 132.

Using the information received from the control system 130, the checkout system 132 automatically applies any product discounts for which the given member customer is eligible. If stored credit information was received from the control system 130, the checkout system 132 prompts the given member customer to enter a PIN or other supplemental identifier and then contacts an outside authorizing network for payment authorization. In order to provide the information display system 100 with additional information regarding product preferences for a given member customer, the checkout system transfers product information, based on product scanning, during the checkout operation to the control system for storage in the associated database. In this manner, the control system 130, in cooperation with the checkout system 132, develops detailed purchasing histories for each member customer. Such histories are useful for example, to display targeted advertising on the various IDUs 112 for a given member customer.

Operation in accordance with the above description offers significant savings in time and enhanced customer service. Because the loyalty information automatically received or accessed at the checkout system 132 for a given customer can include substantial detail, the store may offer various levels of product price discounts targeted to the specific member. Moreover, the automatic transfer of customer credit information facilitates transaction information and greatly reduces the amount of time necessary to secure payment from the member customer.

FIG. 3B illustrates an alternate embodiment for the present invention wherein the CIR 114 mounted proximate the checkout system 132 is adapted to receive information directly from member customers transmitters 220 and the shopping carts 240. As with the CIIDs 110 mounted proximate various product displays, the CIR 114 is adapted to work with either passive customer-carried transmitters 220 or active customer transmitters 220. In this manner, a given member customer automatically transfers their customer information to the checkout system 132 through CIR 114 without need for the shopping cart 240. Indeed, the CIR 114 of the present invention may receive information directly from a shopping cart 240, from an active transmitter 220, or from a passive transmitter 220.

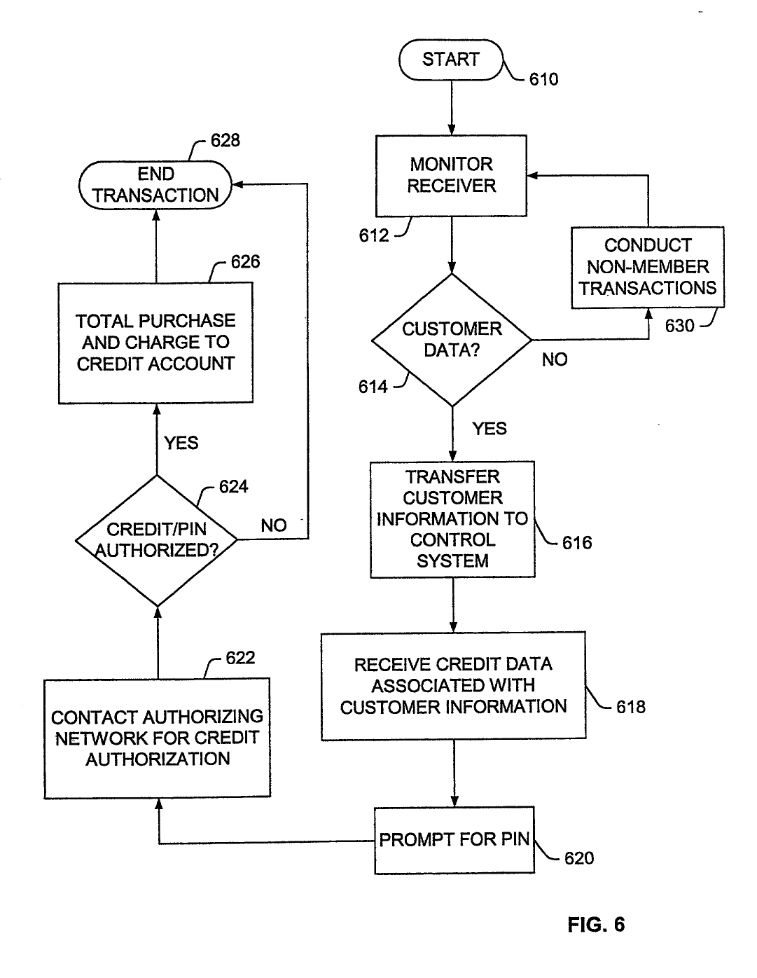

FIG. 6 provides simplified operating logic for the checkout system 132 detailed above. Operation begins (block 610) with the checkout system 132 monitoring its proximate CIR 114 (block 612). If no customer information is received (block 614), the checkout system 132 continues monitoring CIR 114 and is available for other transaction processing (block 630). When customer information is received through CIR 114 (block 614), the checkout system 132 transfers this customer information to the control system 132 (block 616). The control system 130 accesses an associated database to obtain stored loyalty benefit and, preferably, credit information corresponding to the customer for which customer information was received. The control system 132 transfers the loyalty benefit and credit information to the checkout system 130 (block 618). The checkout system 132 prompts the customer for secondary identifying information, such as a PIN, to minimize fraudulent checkout (block 620). The checkout system 132 then contacts an outside credit authorization network to obtain transaction authorization (block 622). If credit authorization is obtained (block 624), the checkout system 132 totals the purchase cost and charges this amount to the customer's credit account (block 626) and operation ends (block 628). If credit authorization is not obtained (block 624), the checkout system ends the credit transaction (block 628). Of course, substantial variation on this general checkout process is possible.

Automatically transferring individual customer information to the checkout system provides tremendous advantages to the individualized customer loyalty program system of the present invention. Further, automatically associating customer credit information in association with customer information received from a shopping cart 240 or customer-carried transmitter 220 can greatly speed up the checkout transaction itself. Indeed, with the automatic transfer of customer information associated with loyalty program and payment information, the system of the present invention can significantly reduce the time required for the checkout transaction. As for loyalty program sophistication, the control system 130, in cooperation with the checkout system 132, can store detailed purchase records for each individual customer. As noted, this information permits the individualized customer loyalty program system to automatically update various aspects of an individual customers loyalty membership standing. The system of the present invention may track the length of time a given customer has maintained membership in the loyalty program and automatically elevate the membership level after a given length of membership, thereby providing enhanced price discounts and promotional offer eligibility to that customer. Further, using product purchase information, the system of the present invention can develop advertising and promotional information tailored to each loyalty program member customer.

Those skilled in the art will readily appreciate the many variations on how this information is transferred and in what particular sequence transaction processing occurs. However, all such variations are considered within the scope of the present invention.

1. A shopping cart for receiving customer information input by a customer and receiving individualized pricing information about a good for purchased based on the customer information, comprising:
a shopping cart;
a customer information input device mounted to said shopping cart, comprising:
a reader for reading the customer information input by the customer; and
a communications interface for receiving the customer information and transmitting the customer information to a control system via a wireless communication;
said communications interface receives loyalty program information about the customer from the control system based on the customer information and causes the price associated with the good be discounted if the customer is a member of a loyalty program.

2. The shopping cart of claim 1, wherein said reader is comprised from the group consisting of a magnetic-stripe card reader, a keypad, an optical reader, and a radio-frequency signal receiver.

3. The shopping cart of claim 1, wherein said communications interface is further adapted to receive credit information from the control system in response to said communications interface sending the customer information to the control system.

4. The shopping cart of claim 1, wherein said loyalty program information causes individualize advertising to be displayed to the customer.

5. The shopping cart of claim 1, further comprising a battery that provides operating power to said customer information input device.

6. The shopping cart of claim 16, wherein said shopping cart includes a charging adaptor electrically coupled to said battery wherein said charging adaptor is adapted to automatically make electrical contact with a shopping cart storage rack for the purpose of automatically recharging said battery while said customer information input device is not in use.

7. A shopping cart system for receiving customer information input by a customer and receiving individualized pricing information about a good for purchased based on the customer information, comprising:
a shopping cart;
a control system communicatively coupled to at least one customer checkout; and
a customer information input device mounted to said shopping cart, comprising:
a reader for reading the customer information input by the customer; and
a communications interface for receiving the customer information and transmitting the customer information to said control system via a wireless communication;
said communications interface receives loyalty program information about the customer from said control system based on the customer information and causes the price associated with the good be discounted if the customer is a member of a loyalty program.

8. The system of claim 7, wherein the discounted pricing is based on a loyalty benefit, with said loyalty benefit corresponding to one of a multiple number of loyalty program membership levels, each level having different discount eligibility.

8. The system of claim 7, wherein said control system is further adapted to cause the price associated with the good to change back to the default pricing inform after a defined interval of time.

9. The system of claim 7, wherein said control system receives a purchasing profile as a part of the customer information received through said customer information input device.

10. The system of claim 9, wherein said control system reads the purchasing profile from an associated database with said control system based on the customer information received through said customer information input device.

11. The system of claim 7, wherein said at least one customer checkout receives discount information about the goods from said customer information input device to provide discount pricing to the customer.

12. The system of claim 7, wherein said reader is comprised from the group consisting of a magnetic-stripe card reader, a keypad, an optical reader, and a radio-frequency signal receiver.

13. The system of claim 7, wherein said communications interface is further adapted to receive credit information from the control system in response to said communications interface sending the customer information to the control system.

14. The system of claim 7, wherein said loyalty program information causes individualize advertising to be displayed to the customer.

15. The system of claim 7, further comprising a battery that provides operating power to said customer information input device.

16. The system of claim 15, wherein said shopping cart includes a charging adaptor electrically coupled to said battery wherein said charging adaptor is adapted to automatically make electrical contact with a shopping cart storage rack for the purpose of automatically recharging said battery while said customer information input device is not in use.

17. A method of providing discounted pricing of a good to a customer in a retail environment, comprising the steps of:
providing a shopping cart that includes a customer information input device;
receiving customer information from a customer;
communicating the customer information to a control system;
receiving loyalty program information about the customer from said control system based on the customer information; and
adjusting the price associated with the good if the customer is a member of a loyalty program.

18. The method of claim 17, further comprising the step of receiving advertising information from said control system.

19. The method of claim 17, wherein said control system is associated with an individual good.

20. The method of claim 17, further comprising the step of communicating the adjustment of the price associated with the good to a customer checkout.

21. The method of claim 20, further comprising the step of automatically adjusting the price associate with the good based on the customer checkout receiving the adjustment of the price.

22. The method of claim 17, wherein said step of receiving customer information comprises receiving a radio-frequency transmission containing the customer information.

23. The method of claim 17, wherein said of receiving customer information comprises receiving data from a card containing the customer information.

24. The method of claim 23, wherein said card is comprised from the group consisting of a magnetic-stripe card, a bar code card, and an optical card.
